(19) United States
(12) Patent Application Publication
(10) Pub. No.: US 2012/0138155 A1
(43) Pub. Date: Jun. 7, 2012

(54) DEVICE FOR ADDING GAS TO FLUIDS

(75) Inventors: Karl August Brensing, Bonn (DE); Michael Dedenbach, Bonn (DE); Rainer Kluth, Bonn (DE)

(73) Assignee: Karl August Brensing, Bonn (DE)

(21) Appl. No.: 13/390,156

(22) PCT Filed: Aug. 16, 2010
(86) PCT No.: PCT/EP2010/061908

§ 371 Date: Feb. 13, 2012

(30) Foreign Application Priority Data
Aug. 14, 2009 (DE) 102009026376.4

(51) Int. Cl. F15C 1/00; B01F 3/04

(52) U.S. Cl. 137/1; 261/119.1

(57) ABSTRACT

An apparatus for introducing a gas into a liquid in a flow tube includes at least one feed line for the liquid to be gassified and the gas to be introduced, at least one outflow line for a gas/liquid mixture, at least one return line for the gas/liquid mixture, and at least one chamber comprising at least one gas supply device arranged in the at least one return line. The apparatus does not include an injector operating on a Venturi principle.

### CROSS REFERENCE TO PRIOR APPLICATIONS

This application is a U.S. National Phase application under 35 U.S.C. §371 of International Application No. PCT/EP2010/061908, filed on Aug. 16, 2010 and which claims benefit to German Patent Application No. 10 2009 026 376.4, filed on Aug. 14, 2009. The International Application was published in German on Feb. 17, 2011 as WO 2011/018529 A1 under PCT Article 21(2).

### FIELD

The present invention provides an apparatus for introducing gas into liquids.

### BACKGROUND

The introduction of gas is of importance in many areas of technology. Corresponding processes are carried out when performing procedures for bringing gases into contact with liquids to carry out mass transfer and energy exchange processes. For example, the process of exchanging gas and liquid flows takes place in packing columns, gas and liquid usually being made to flow in counter-current. The liquid thus flows downward on the walls of a column and on the surface of the packing, and thereby comes into contact with the upwardly flowing gas. Such an installation is described, for example, in DE 32 28 045 A1. Further installations that are used for enriching liquid with gas are described, for example, in DE 32 20 451 A1, DE 37 37 424 A1, DE 102 46 452 A1, DE 103 40 024 B3, EP 0 394 629 A1, EP 1 405 829 A1 and EP 1 491 495 A1.

An important application area for the introduction of gases into liquids is the disinfection and sanitization of containers and systems of lines. Here, the gas is introduced in the form of oxidizing agents.

Hygienically questionable states may occur in systems that are exposed to liquids such as, for example, water. Biofilms may, for example, form on walls of lines. These comprise biocenoses that allow microbial life embedded in a matrix of extracellular polymeric substances. One of the functions of the extracellular polymeric substances is to provide external protection from pH fluctuations, salts, hydraulic loading, toxic heavy metals, antibiotics and immune defense mechanisms. The matrix structure leads to an enormously high resistance of the lifeforms concerned, which for these reasons are sometimes up to thousands of times more resistant to antimicrobial agents than the individual organisms (Gilbert, P., Das, J. and Foley, I. (1997) Biofilm susceptibility to antimicrobials Adv Dent Res 11(1): 160-167; Costerton, J. W. Stuart, P. S. and Bönberg, E. P. (1999) Bacterial biofilms: a common cause of persistent infections, Science 284: 1318-1322).

Studies have shown that a large proportion of infections are caused by such biofilms and that they may have life-threatening effects, for example, in hospitals (Lasa, I., Del Pozo, J. L., Penades, J. R., Leiva, J. (2005) Bacterial biofilms and infection, An. Sist. Sanit. Navar. 28: 163-175). Problematic biofilm bacteria include Pseudomonas aeruginosa, Legionella pneumophila, Acinetobacter, atypical mycobacteria and Serratia. Pseudomonas aeruginosa are attributable to contaminated tap water (Reuter, S., Sigge, A., Reuter, U. et al. (2002) Endemische Übertragungswege von Pseudomonas aeruginosa [endemic means of transmission of Pseudomonas aeruginosa], Hyg Mikrobiol 6: 6-12). Such infections therefore represent a considerable problem, for example, in intensive care units, dialysis centers or surgery departments.

The formation of biofilms is a considerable potential hazard, for example, in the case of dialyses. This is so because certain elements of the water treatment installations of dialysis devices, for example, filters, ion exchangers or membranes, are conducive to the development of such biofilms. Additional factors that are conducive to the breeding of bacteria are, for example, dead spaces in water pipeline systems, low or no rates of flow and the use of bicarbonate concentrate, which is used for preparing the dialyzing fluids.

Among the suitable disinfectants is ozone. This gas has been used, for example, in the food industry, in the treatment of drinking and waste water and in dental treatment. Corresponding installations for the use of ozone are described, for example, in DE 10061890 A1, DE 1016365 A1, DE 29806719 U1, DE 3225674 A1, DE 202008001211 U1 and EP 0 577 475 A1. Ozonizing installations of various configurations are described, for example, in U.S. Pat. No. 4,252,654 A, CH 365342 A, DE 3737424 A1, DE 3830909 A1 and US 2006/0237557.

Ozone has found little use in dialysis devices. Brensing et al. Hyg Med 2009, 34, nevertheless describes what microbiological advantages are gained by daily ozonizing of the ring line systems of dialysis devices. However, no solution in terms of process engineering and equipment is provided. There is therefore a great need for solutions for the use of ozone, for example, in the area of dialysis. This is so because the materials that are usually used for the ring line systems are not thermally stable. Although PVC surfaces are of advantage for delaying the occurrence of biofilms, disinfection by using heat is not suitable for dialysis devices because of the lack of thermal stability. In cases where thermally stable lines are used, the disinfecting processes are very water-intensive and use considerable amounts of energy. A further problem arises in the case of emergency dialyses that have to be carried out within a short time. This is so because disinfection by using heat may require cooling times of 2 to 3 hours before a dialysis can be safely performed.

On the other hand, chemical disinfections are time-consuming, expensive and require considerable effort with respect to checking for freedom from residual chemicals. Added to this is the fact that the chemicals do not act sufficiently on biofilms.

### SUMMARY

An aspect of the present invention is to provide an apparatus for introducing gas into liquids which is compact and versatile in its use and which does not use injectors operating on the Venturi principle.

In an embodiment, the present invention provides an apparatus for introducing a gas into a liquid in a flow tube which includes at least one feed line for the liquid to be gassified and the gas to be introduced, at least one outflow line for a gas/liquid mixture, at least one return line for the gas/liquid mixture, and at least one chamber comprising at least one gas supply device arranged in the at least one return line. The apparatus does not include an injector operating on a Venturi principle.

### BRIEF DESCRIPTION OF THE DRAWINGS

The present invention is described in greater detail below on the basis of embodiments and of the drawings in which:

FIG. 1 shows the apparatus according to the present invention in counter-current operation;

FIG. 2 shows the apparatus according to the present invention as a co-current variant;

FIG. 3 shows the use of the apparatus according to the present invention in the embodiment of a dialysis disinfecting installation;

FIG. 4 shows an embodiment of batch mode; and

FIG. 5 shows an embodiment in a beverage vending machine.

### DETAILED DESCRIPTION

The present invention operates independently of fluctuations in flow and pressure. This process may also be referred to as an active concentrator. The apparatus can be used in disinfecting and sanitizing processes, for example, in systems that are thermally unstable. The unit can, for example, be used in the medical area, such as in the area of dialysis devices.

The apparatus for introducing gas into liquid may be operated in counter-current or co-current. In other words, the gas and the liquid may be introduced into the flow tube from the same side, or else be introduced in counter-current to each other.

The return of the partial amount of the gas/liquid mixture contains feed modules for enrichment with gaseous oxidizing agent, for example, ozone.

The feed modules serve as introducing systems and can, for example, consist of a cylindrical bore. The configuration can, for example, be in the form of a pointed cone. The cone, for example, the tip of the cone, is adjoined by the beginning of the return line, which is chosen in its dimensioning such that a vortex is produced by increasing the flow rate inside the cylindrical bore. This vortex reduces the size of the bubbles entering (macrobubbles become microbubbles). If an electrolytic ozone cell is used, the vortex formation accelerates separation of the bubbles at the generator.

In an embodiment of the present invention, the cone envelope can, for example, be inclined at an angle of 10° to 80°, for example, at an angle of 45° to 60°, in relation to the perpendicularly/vertically aligned wall of the chamber. The diameter of the following channel to the return line can, for example, be 1 to 12 mm, or for example, 2 to 9 mm. The diameter of the return channel can, for example, represent 10 to 40%, or for example, 15 to 30%, of the cylinder bore of the chamber diameter.

A further introducing step may be provided by a downstream positive displacement pump, for example, a gear pump. By further reducing the size of the bubbles and, for example, increasing the pressure, the oxidizing agent, for example, ozone, can then be dissolved as well as possible in the water. The positive displacement pump can, for example, be arranged downstream of the cylindrical bore such that the system operates in a sucking manner. It is thereby possible for the introducing system to operate independently of flow and position and for the recirculation volume into the flow tube consequently to be controlled variably with respect to the throughflow volume of the liquid to be enriched.

Any number of these modules may be arranged one behind the other. The number of modules is suitable for optimizing the amount of gas introduced for the respective application. The repeated return brings about optimal utilization and concentration of the supplied gas into the liquid.

In an embodiment of the present invention, it is possible that the process is characterized in that the gas and the liquid in the flow tube may also come from a number of gas introducing modules arranged in parallel. In other words, any desired combination for co-current and counter-current arrangements is conceivable. For example, one unit may be operated in co-current and a number of others may be operated in counter-current.

The introducing system consequently operates as a concentrator. This has the task of increasing the concentration of oxidizing agent, for example, ozone, in the water. The water enriched with gaseous oxidizing agent is thereby repeatedly passed over the introducing system. The water is thereby re-enriched with the oxidizing agent. Serving here as a reactor is a hollow space that has been introduced into the block or configured on its own. The concentrator may in this case be operated on the co-current or counter-current principle—as already mentioned above. The reaction spaces or hollow spaces required for it to operate may be constructed, for example, as bores in a block or discretely. Apart from the devices described, the introducing system and the downstream liquid systems may also include inter alia degassing devices. Here, excess oxidizing agent, for example, the ozone, can be carried away or returned.

The apparatus according to the present invention can be used in any desired systems. It may be used for flow gas enrichment. Here it is possible that enrichment of ozone in liquids is carried out as flow ozonization. However, a process in batch mode is similarly possible, i.e., the ozonization of liquids is carried out in batch mode, the volume being removed from a working vessel and a step-by-step ozonization of a liquid being achieved by repeated circulation over the flow tube or introducing system according to the present invention. This is generally carried out with ozone concentrations from about 20 ppb and many times more.

One advantage of the installation according to the present invention is that it is also possible to work under positive pressure. Dialysis devices are typically operated at an operating pressure of up to 6 bar. The installation can, for example, be designed for pressures of 0-15 bar, or, for example, for pressures of 0-8 bar. However, the structural design also means that higher pressures are also possible with the gas introducing system.

The apparatus according to the present invention is suitable for processes for sanitization and disinfection. In other words, gaseous oxidizing agents can, for example, be enriched in the apparatus and used for disinfection and sanitization. Ozone can, for example, be used as an oxidizing agent. However, other oxidizing disinfectants also come into consideration, such as: sodium hypochlorite, calcium hypochlorite, chlorine, electrolytically prepared chlorine compounds, chlorodioxide solutions, hydrogen peroxide, based on peracetic acid.

Ozone offers a series of advantages over other oxidizing agents and over conventional disinfectants. For example, the biofilm is reliably removed and the bacterial count significantly reduced, and no chemical residues remain; this is so because ozone breaks down in oxygen. The re-formation of a biofilm is furthermore suppressed. Only extremely small concentrations are furthermore used. Using ozone also makes it possible to work without heat. Effective cold disinfection and sanitization can therefore be carried out.

In an embodiment of the present invention, ozone can, for example, be produced directly in the installation in a special generating device. All of the methods known to a person skilled in the art come into consideration therefor.

In principle, the ozone may be produced from oxygen with the addition of energy by means of so-called silent electrical discharges.

The ozone formation takes place here by recombination of an oxygen molecule with an oxygen atom. A splitting of an oxygen molecule by electrical energy must therefore take place. This is achieved in a gas space between two electrodes that are separated by a dielectric. Alternating current and a high-voltage field are applied to the electrodes. The ozone generating units in the form of glass or ceramic tubes are usually positioned in high-grade steel tubes, so that an annular discharge gap that is as narrow as possible is produced. A corresponding number of these ozone generating modules may then be used for the production of amounts of ozone of a few grams/hour up to many kilograms/hour. Either oxygen or air is used as the operating gas.

It is also possible, by using UV light, to generate ozone from the operating gas (oxygen or air), i.e., the electrical splitting of oxygen may also be performed by radiant energy. UV lamps with radiation wavelengths of approximately 185 nm can, for example, be used therefor. At this wavelength, molecular oxygen absorbs energy and is split into atoms. The recombination of the atoms then leads to the ozone molecule. The UV-ozone generators usually consist of an irradiating reactor with a built-in lamp, past which the oxygen-containing operating gas flows and is converted into ozone. These units can, for example, be used for small amounts of ozone of a few grams/hour.

An alternative is production from liquid that contains oxygen, for example, from water. The ozone is here produced by using energy, for example, electrical energy. This involves generating ozone from the oxygen of the water molecule by means of electrolytic water splitting (as described in DE 000004222732 C2, EP 0000000068522 A1). In a flow cell, there are special electrodes (for example, an anode with a solid electrolyte and a cathode), which are flowed around by the water. A DC voltage source generates the required electrolysis current, which leads to the ozone gas generation at the anode. The process concerned can be used primarily for small amounts of ozone of a few grams/hour. If electrolytic ozone generators are used in fully demineralized water, once the voltage is switched off, a suitable protective voltage must be applied in order that the electrodes of the cells are not damaged.

The installation described has considerable advantages over the prior art. As a compact central unit, it can be adapted for any installation and can be used for cold disinfection and penetration. The compact structure with the external dimensions of, for example, 35-45×45-65×70-90 cm, or, for example, of 38-42×48-60×75-85 cm, or, for example, of 40×50×80 cm, makes this system suitable for mobile use. Special mention should be made of the structure; a closed system that is not connected to the atmosphere by way of a vessel or tank. This construction circumvents the disadvantages of the Venturi system, which breaks down when there are changes in pressure or interruptions in flow. While including suitable couplings and valves, the system makes it possible for complete disinfection and sanitization to be performed without any dead space by means of decentralized branch line perfusion without active end consumers. The regular disinfection is highly effective and inexpensive, since no ring line or transfer module conversion is necessary, and there are virtually no, or only low, consequent costs in comparison with hot disinfection. Biofilm formation is furthermore completely or largely prevented, and no chemical residues remain. The ozone breaks down into non-toxic oxygen. On the other hand, even very small ozone concentrations are microbiologically very effective.

The apparatus according to the present invention may also be used inter alia because of its compact form of construction for the periodic disinfection of water treatment systems such as ion exchangers for softening and reverse osmoses. Apart from dialysis, it can be used in other areas of medical and laboratory technology, and similarly in drinking water preparation and the conservation of liquids. Use in laboratory water supply systems, hospitals and care facilities, in beverage and beverage vending machine technology are similarly conceivable. Further application areas comprise fish and livestock husbandry as well as hot water, heating and air conditioning technology, for example, in hotels, saunas, spa pools and swimming pools. Applications in process and waste-water treatment are also possible.

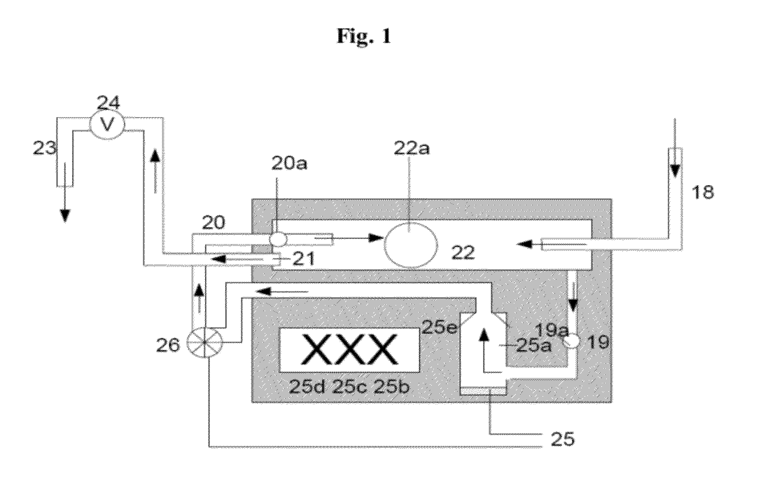

The ozone generating and introducing system according to the present invention is shown in detail in the embodiment according to FIG. 1. According thereto, water to be ozonized is introduced via the line 18. The line 19 is used for sucking in liquid for introducing ozone into the ozonizing chamber 25 a by means of a positive displacement pump 26, and the return line 20 is used for returning it into the flow tube 22. The ozonizing chambers 25 a, b, c and d are provided with an ozone-introducing feed line 25. The return line 20 ends in the flow tube 22 with the outflow 21. The enriched ozone-liquid mixture leaves the flow tube 22 via the outflow 23. If need be, the valve 24 can be switched such that the liquid flow from 18 to 23 is throttled and/or stopped. The liquid-gas mixture is initially circulated by means of the pump 26, until optimal enrichment has taken place. Arranged in the ozonizing chamber 25 a is a conical nozzle 25 e for introducing ozone into the liquid sucked in. If need be, further chambers 25b, 25c and 25d may also be arranged. Flow, temperature and gas-bubble measuring, controlling and regulating devices 19a, 20a, 22a may be arranged in the lines 19, 20 or 22. The lines 18 and 20 introduce liquid and ozone into the flow tube 22 in counter-current.

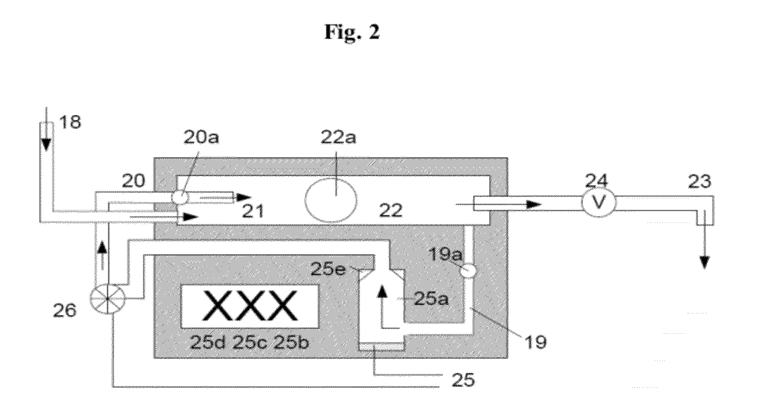

In the embodiment according to FIG. 2, all of the parts have the same function as in FIG. 1. The only difference is that the lines 18 and 20 carry the liquid 18 to be enriched and ozone or the gas mixture into the flow tube 22 in co-current.

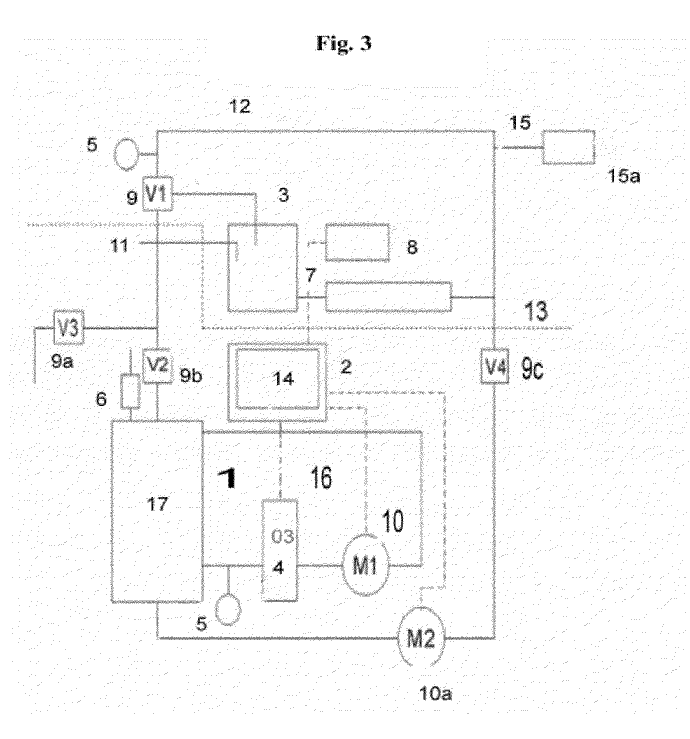

FIG. 3 shows the incorporation of the present invention according to FIG. 1 or 2 in the embodiment of disinfection of a ring line with a connected end consumer (15a) of a dialysis device. The end consumer 15a is connected via the branch line 15 to the return of the ring line 12. The reverse osmosis control 8 can be switched on or off by means of the start-stop input. The ozone/water mixture coming from the ozone-generating and introducing system 4 is made to enter the working vessel 17. The ozone generator is arranged upstream on the suction side of the circulating pump 10. The control takes place by means of the device 2, which in the embodiment has a touchscreen 14. The ozone concentration can be measured by means of the device 5 in the inner circulation 1 and in the outer circulation 3. By means of the circulating pump 10, the ozone is taken along in the inner circulation 1 and the water is enriched with ozone. As a result, the working vessel 17 undergoes disinfection. The excess ozone is carried away by means of the degassing device 6.

In the case of the inner disinfection, the ozone concentration of at least 30 ppb in the working vessel 17 is kept constant for about 10 to 15 minutes. Once the disinfection in the inner circulation 1 has been completed, the outer circulation 3 can be attached and operated by means of pressure-increasing pumps 10a. This involves the (dialysis) ring line 12, and the end consumers 15a attached by means of the branch line(s) 15.

Once a parameterizable ozone concentration has been reached, at least 30 ppb, the adjustable reaction time begins. The ozone concentration in the outer circulation 3 and in the inner circulation 1 is at the same time measured and recorded by means of the ozone measuring device 5.

After completion of the disinfection, the system is flushed out with the permeate of the reverse osmosis via the channel valve 9a. At the same time, the ozone concentration in the return of the ring line 12 is measured. After an adjustable flushing time in which the line is flushed out with a multiple of its content and the ozone concentration in the ring line 12 (return) is less than 10 ppb, the flushing is completed and the installation is released again for dialysis.

In the case of an emergency dialysis, the disinfection is interrupted and the installation is flushed as described. As a result, the ring line is generally available again for dialysis operation at the latest after 30 minutes.

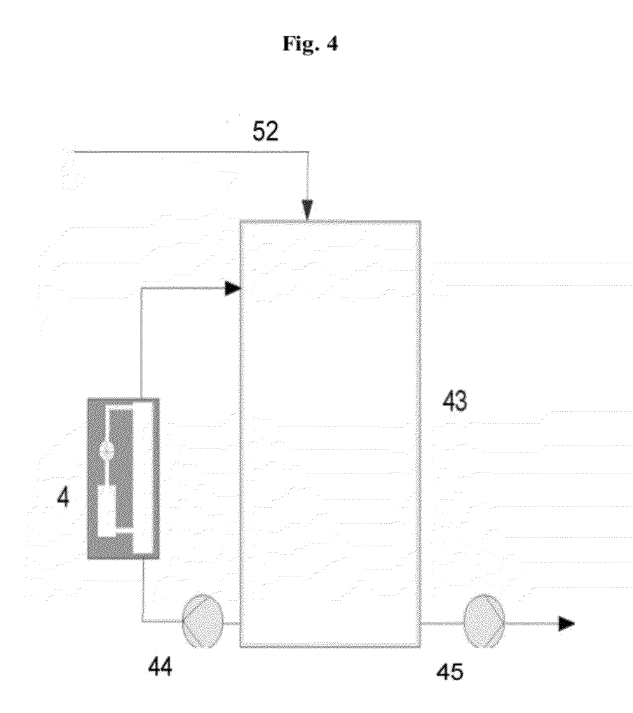

FIG. 4 shows the incorporation of the device according to FIG. 1 and FIG. 2 in the embodiment of a re-concentration of a batch vessel 43 after filling via the feed line 42. This involves circulating medium from the batch vessel 43 by means of a feed pump 52 over the ozone-generating and introducing device 4 until the desired concentration is reached in the batch vessel 43. If need be, the medium that is enriched with ozone is then pumped by means of the pump 45 to the consumer or for further use.

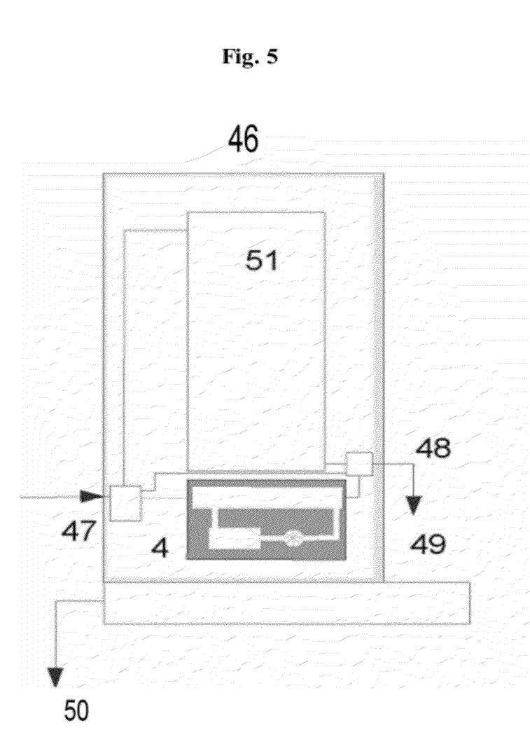

FIG. 5 shows the incorporation according to FIG. 1 or FIG. 2 in the embodiment of a beverages machine 46. Valve block 1 (47) is used for the filling of the beverage preparation unit 51. The valve block 2 (three-way valve 48) is used if need be for controlled feeding to the ozone-generating and introducing unit 4 or to the removal point 49 of the beverages machine 46. The beverages machine can be emptied by way of the drain 50.

The present invention is not limited to embodiments described herein; reference should be had to the appended claims.

### LIST OF DESIGNATIONS

1 Inner circulation
2 Control device
3 Outer circulation
4 Ozone-generating and introducing device (active concentrator)
5 Ozone measuring device
6 Degassing device
7 Connecting line to the reverse osmosis control
8 Reverse osmosis control
9 Dialyzing ring/disinfections switching valve
9a Channel valve
9b Filling valve
10 Circulating pump (inner circulation)
10a Pressure-increasing pump (outer circulation)
11 Soft water replenishment for reverse osmosis
12 Ring line
13 Flow
14 Touchscreen
15 Branch line(s)
15a End consumer
16 Connection of ozone-generating device 4 to control 2
17 Working vessel
18 Line for water to be ozonized
19 Line for sucking in liquid for ozone introduction
19a Flow, temperature, gas-bubble controlling and regulating device
20 Return line
20a Flow, temperature, gas-bubble controlling and regulating device
21 Outflow
22 Flow tube
22a Flow, temperature, gas-bubble controlling and regulating device
23 Outflow
24 Valve
25 Ozone supply
25a, 25b, 25c, 25d Ozonizing chambers
25e Conical nozzle
26 Pump
42 Feed line
43 Batch vessel
44 Circulating pump
45 Production pump
46 Beverages machine
47 Valve block 1
48 Valve block 2
49 Removal point
50 Drain
51 Beverage preparation unit
52 Feed pump

What is claimed is:

1-16. (canceled)

17. An apparatus for introducing a gas into a liquid in a flow tube, the apparatus comprising:
at least one feed line for the liquid to be gassified and the gas to be introduced;
at least one outflow line for a gas/liquid mixture;
at least one return line for the gas/liquid mixture; and
at least one chamber comprising at least one gas supply device arranged in the at least one return line;
wherein the apparatus does not include an injector operating on a Venturi principle.

18. The apparatus as recited in claim 17, wherein the at least one feed line and the at least one return line are arranged so as to provide a counter-current operation.

19. The apparatus as recited in claim 17, wherein the at least one feed line and the at least one return line are arranged so as to provide a co-current operation.

20. The apparatus as recited in claim 17, wherein the at least one gas supply device is an ozone device.

21. The apparatus as recited in claim 17, wherein the at least one chamber consists of a cylindrical bore configured to receive a gas introducing system configured as a pointed cone.

22. The apparatus as recited in claim 21, further comprising a channel arranged at a tip of the pointed cone, wherein the channel is configured to produce a vortex so as to reduce a size of bubbles by increasing a flow rate inside the cylindrical bore.

23. The apparatus as recited in claim 21, wherein an inclination of a wall of the pointed cone is between 10° and 80°.

24. The apparatus as recited in claim 21, wherein a diameter of the at least one chamber is greater than a diameter of the at least one return line by 10 to 40%.

25. The apparatus as recited in claim 17, wherein the apparatus has a pressure of from 0 to 15 bar.

26. A process for introducing a gas into a liquid in a first flow tube, the process comprising:
introducing the gas and the liquid into the first flow tube so as to provide a gas/liquid mixture;
withdrawing the gas/liquid mixture from the first flow tube 22 via a first line, a second flow tube and a second line;
performing a gas enrichment of the gas/liquid mixture in at least one of the first line and the second line so as to provide an enriched gas/liquid mixture;
returning the enriched gas/liquid mixture to the first flow tube; and
conveying away the enriched gas/liquid mixture via an outflow line.

27. The process as recited in claim 26, further comprising a positive displacement pump configured to operate in a sucking manner, wherein the positive displacement pump is configured to introduce the gas/liquid mixture into the first line.

28. The process as recited in claim 26, further comprising more than one gas introducing module arranged in parallel, wherein the gas and the liquid in the first flow tube can be withdrawn by the more than one gas introducing module.

29. The process as recited in claim 26, wherein the gas is ozone, and the gas enrichment with the ozone is performed as a flow ozonization.

30. The process as recited in claim 26, wherein the process is a flow ozonization.

31. The process as recited in claim 26, wherein the process is performed as a batch process further comprising:
removing a volume from a working vessel; and
enriching the gas in the liquid via a step-by-step introduction of the gas through repeated circulation over at least one of the first flow tube and an introducing system.

32. The process as recited in claim 26, wherein the gas is ozone and the process provides for an ozonization of the liquid in a beverage vending machine, whereby a first valve block is configured to fill a beverage preparation unit, and a second valve block (three-way valve) is configured to feed to at least one of an ozone-generating unit and a removal point.
